(19) United States
(12) Patent Application Publication
(10) Pub. No.: US 2026/0371436 A1
(43) Pub. Date: Nov. 19, 2026

(54) METHOD, APPARATUS, AND SYSTEM FOR MULTIPLE DRX MANAGEMENT IN A WIRELESS NETWORK

(71) Applicant: Continental Automotive Technologies GmbH, Hannover (DE)

(72) Inventors: Rikin Shah, Langen (DE); David Gonzalez Gonzalez, Egelsbach (DE); Andreas Andrae, Frankfurt am Main (DE); Hojin Kim, Regensburg (DE); Reuben George Stephen, Singapore (SG); Osvaldo Gonsa, Frankfurt (DE)

(73) Assignee: Continental Automotive Technologies GmbH, Hannover (DE)

(21) Appl. No.: 19/141,186

(22) PCT Filed: Dec. 1, 2023
(86) PCT No.: PCT/EP2023/083866

§ 371 Date: Jun. 19, 2025

(30) Foreign Application Priority Data
Dec. 19, 2022 (DE) 10 2022 213 924.0

(51) Int. Cl. H04W 76/28

(52) U.S. Cl. CPC H04W 76/28

(57) ABSTRACT

The present disclosure relates to methods, apparatus and systems for configuring and controlling discontinuous reception in a user equipment connected to a wireless network. An aspect of the disclosure relates to a method comprising steps of receiving a primary DRX cycle configuration and at least one secondary DRX cycle configuration, configuring said primary DRX cycle and said secondary DRX cycle, and activating only said primary DRX configuration. The method further comprises steps of receiving from a network node, during said primary DRX cycle, a command for activating said at least one secondary DRX cycle and activating said secondary DRX and receiving downlink data during said secondary DRX cycle.

### CROSS-REFERENCE TO RELATED APPLICATIONS

The present application is a National Stage Application under 35 U.S.C. § 371 of International Patent Application No. PCT/EP2023/083866 filed on Dec. 1, 2023, and claims priority from German Patent Application No. 10 2022 213 924.0 filed on Dec. 19, 2022, the disclosures of which are herein incorporated by reference in their entireties.

### TECHNICAL FIELD

The present disclosure relates generally to discontinuous reception in wireless devices and more particularly to a method for optimizing power consumption when using multiple DRX configurations in a user equipment.

### BACKGROUND

In order to limit power consumption in LTE (Long Term Evolution), 5G or NR (New Radio) telecommunication systems, 3GPP (Third Partnership Project) introduced DRX (Discontinuous Reception) mode.

Because downlink data may arrive at any time, a user equipment (UE) needs to constantly monitor Physical Downlink Control Channel (PDCCH) in order to check if there is downlink data available. This consumes a lot of power.

DRX makes it possible for the user equipment (UE) to reduce power consumption by discontinuously receiving PDCCH: UE periodically enters a sleeping state for a certain period of time (OFF duration) during which PDCCH is not monitored before waking up for another period of time (ON duration) to monitor PDCCH for possible downlink data. DRX thus allows a reduction of power consumption.

UE and network need to be synchronized to avoid the network trying to send data while the UE is in sleeping state. To this end, the network configures UE with a set of DRX parameters, including “onDurationTimer” and “inactivityTimer” as defined in 3GPP specification TS 38.321. When a DRX period starts, UE stays active for a time period, referred as a “ON period”, which is configured through “onDurationTimer” parameter. If there is no PDCCH received during this time, the UE would enter DRX sleep state until the next active period. Whenever some activity occurs on PDCCH during the activity period, UE remains active and keeps monitoring for PDCCH for a duration configured through “inactivityTimer” parameter.

In some applications, like XR (augmented Reality), different traffic flows may be established between UE and a serving base station, including video, audio and pose flows, either in uplink or downlink directions. A base station may configure different overlaid DRX configurations to support such distinct traffic flows.

Unfortunately, multiple DRX configurations would increase UE's active time and, as a result, power consumption would also increase.

There is therefore a need for a method that would allow to reduce UE's active time when multiple DRX configuration are configured by a base station.

### SUMMARY

An aspect of the disclosure relates to a method of wireless communication for configuring multiple discontinuous reception (DRX) cycles by a user equipment connected to a wireless network, said method comprising steps of:
Receiving DRX configuration parameters through Radio Resource Control (RRC) signaling, said parameters comprising a primary DRX cycle configuration and at least one secondary DRX cycle configuration,
Configuring said primary DRX cycle and said secondary DRX cycle, and activating only said primary DRX configuration,
Receiving from a network node, during said primary DRX cycle, a command for activating said at least one secondary DRX cycle, and
Activating said secondary DRX and receiving downlink data during said secondary DRX cycle.

A primary DRX cycle and a secondary DRX cycle are thus preconfigured in a user equipment, based parameters provisioned by a network node. The primary DRX cycle is activated upon reception of said configuration, whereas the secondary DRX cycle is activated only on-demand, that is to say when a network node has some downlink data to transmit on said secondary DRX. This allows a user equipment to save power, by activating the secondary DRX only if downlink data transfer is expected. In contrast, a primary DRX cycle is kept active for receiving commands for activating the secondary DRX.

According to an embodiment, the method for configuring multiple DRX further comprises a step of receiving during a primary DRX cycle, a command for deactivating at least a secondary DRX cycle.

The user equipment may thus receive a command from the base station to deactivate a secondary DRX configuration when no more downlink data is expected to be transmitted on said secondary DRX cycle. Power consumption is even more reduced.

According to an embodiment, the received DRX activation command comprises at least an instruction for time-shifting said at least one secondary DRX cycle.

A base station may thus adjust the time location of each ON duration period of a secondary DRX cycle to better match incoming downlink data rate. This contributes to lower latency and better makes use ON periods.

According to an embodiment, the secondary DRX cycle activation command is received through Physical Layer and/or Medium Access Control Layer signaling.

Using L1/L2 signaling is faster than using Radio Resource Control signaling. The method thus allows better performances.

It is also contemplated that the secondary DRX cycle activation command is carried over Medium Access Control Control Element (MAC CE) and/or Physical Downlink Control Channel (PDCCH).

According to an embodiment, the secondary DRX cycle activation command is transmitted in a 8 bits field of a Medium Access Control (MAC) subheader with Logical Channel Indentifier (LCID).

According to an embodiment, the secondary DRX activation command is transmitted in a 3 bits field of a Downlink Control Information (DCI) Format.

Thanks to the secondary DRX cycles being preconfigured, this allows transmitting DRX activation command with very low signaling overhead using only one bit per secondary DRX configuration to activate/deactivate.

Another aspect of the disclosure relates to a method of wireless communication performed by a base station for controlling multiple discontinuous reception (DRX) cycles in a user equipment connected to a wireless network, said method comprising:
Sending a primary DRX cycle configuration and at least one secondary DRX cycle configuration to a user equipment,
Receiving downlink data destinated to said user equipment,
Determining at least one secondary DRX cycle associated with the received data,
Transmitting on said primary DRX cycle, a command for activating said determined secondary DRX cycle,
Transmitting said downlink data the user equipment on said secondary DRX cycle.

Such a method allows a base station to selectively activate a preconfigured secondary DRX configuration when downlink data is available for transmission on said secondary DRX cycle.

A primary DRX cycle and a secondary DRX cycle are thus transmitted to a user equipment for preconfiguration. The primary DRX cycle is intended to be activated upon reception of said configuration, whereas the secondary DRX cycle is initially deactivated and activated only on-demand, that is to say when a network node has some downlink data to transmit on said secondary DRX. This allows the user equipment to save power, by activating the secondary DRX only if downlink data transfer is expected. In contrast, a primary DRX cycle is kept active, allowing the base station to send commands for activating the secondary DRX.

According to an embodiment, the method for controlling DRX further comprises a step of sending on said primary DRX cycle, a command for deactivating said at least one secondary DRX cycle when no downlink data is pending for transmission on said secondary DRX cycle.

The base station may thus deactivate a secondary DRX configuration previously activated in a user equipment when no more downlink data is expected to be transmitted on said secondary DRX cycle. This allows saving power.

According to an embodiment, said secondary DRX cycle activation command transmitted comprises at least an instruction for time-shifting said at least one secondary DRX cycle.

The base station may thus adjust the time location of each ON duration period of a secondary DRX cycle to better match incoming downlink data rate. This contributes to lower latency and better makes use ON periods.

According to an embodiment, said secondary DRX cycle activation command is transmitted through Physical Layer and/or Medium Access Control Layer signaling.

According to an embodiment, said secondary DRX cycle activation command is carried over Medium Access Control Control Element (MAC CE) and/or Physical Downlink Control Channel (PDCCH).

According to an embodiment, said secondary DRX cycle activation command is transmitted in a 8 bits field of a Medium Access Control (MAC) subheader with Logical Channel Identifier (LCID).

According to an embodiment, said secondary DRX cycle activation command is transmitted in a 3 bits field of a Downlink Control Information (DCI) format.

The disclosure also contemplates an apparatus for configuring multiple discontinuous reception (DRX) cycles in a user equipment connected to a wireless network, said apparatus comprising a processor coupled with a memory, said memory comprising computer program instructions stored therein for controlling said processor, wherein said computer program instructions are configured to implement the following acts:
Receiving DRX configuration parameters through RRC signaling, said parameters comprising a primary DRX cycle configuration and at least one secondary DRX cycle configuration,
Configuring said primary DRX cycle and said secondary DRX cycle, and activating only said primary DRX configuration,
Receiving from a network node, during said primary DRX cycle, a command for activating said at least one secondary DRX cycle, and
Activating said secondary DRX and receiving downlink data during said secondary DRX cycle.

The disclosure further contemplates an apparatus for controlling multiple discontinuous reception (DRX) cycles in a wireless network, said apparatus comprising a processor coupled with a memory, said memory comprising computer program instructions stored therein for controlling said processor, wherein said computer program instructions are configured to implement the following acts:
Sending a primary DRX cycle configuration and at least one secondary DRX cycle configuration to a user equipment,
Receiving downlink data destinated to said user equipment,
Determining at least one secondary DRX cycle associated with the received data,
Transmitting on said primary DRX cycle, a command for activating said determined secondary DRX cycle,
Transmitting said downlink data the user equipment on said secondary DRX cycle.

According to another aspect, it is proposed a wireless user equipment comprising an DRX configuration apparatus and a wireless base station comprising an apparatus for controlling DRX as describer hereinabove.

The disclosure also contemplates a wireless communication system comprising at least said user equipment and said base station.

According to an embodiment, steps of the methods described hereinabove are determined by computer program instructions.

Consequently, an embodiment of the present disclosure relates to a computer program stored on an information medium, said program being suitable to be implemented in user equipment device or more generally in a computer, said program comprising instructions configured to implement steps of the method for configuring DRX and/or steps of the method for controlling DRX which has just been described.

The program can use any programming language, and be in the form of source code, object code, or of code intermediate between source code and object code, such as in a partially compiled form, or in any other desirable form.

A further aspect contemplates a computer-readable information medium comprising computer program instructions for implementing steps of the method mentioned hereinabove.

The information medium may be any entity or device capable of storing the program. For example, the medium can comprise a storage means, such as a ROM, for example a CD ROM or a microelectronic circuit ROM, FLASH memory or any magnetic recording means, for example a hard drive.

Moreover, the information medium may be a transmissible medium such as an electrical or optical signal, which may be conveyed via an electrical or optical cable, by radio or by other means.

Alternatively, the information medium may be an integrated circuit into which the program is incorporated, the circuit being adapted to execute or to be used in the execution of the methods in question.

The advantages of the apparatus, user equipment, wireless system, computer program and information medium are identical to those presented in relation with the corresponding method according to any one of the embodiments mentioned hereinabove.

### BRIEF DESCRIPTION OF THE DRAWINGS

Other advantages and characteristics of the invention will be more clearly apparent on reading the following description, given by way of simple illustrative and nonlimiting example, and the appended drawings, among which:

FIG. 1 is a schematic diagram of a wireless communication system in which aspects of the method disclosed herein may be practiced, according to an embodiment,

FIG. 2a is a schematic diagram showing an active primary DRX cycle configuration and an inactive secondary DRX cycle configuration on a user equipment, according to an embodiment,

FIG. 2b is a schematic diagram showing an active primary DRX cycle configuration and an active secondary DRX cycle configuration on a user equipment, according to an embodiment,

FIG. 3 is a flow chart illustrating steps of a method performed by a user equipment for configuring discontinuous reception, according to an embodiment of the present disclosure,

FIG. 4 shows an exemplary MAC CE format for commanding secondary DRX configuration activation and/or deactivation,

FIG. 5 is a flow chart illustrating steps of a method performed by a base station for controlling discontinuous reception in a user equipment, according to an embodiment of the present disclosure,

FIG. 6 is a bloc diagram illustrating an apparatus suitable for implementing a method for configuring DRX, according to an embodiment, and

FIG. 7 is a bloc diagram illustrating an apparatus suitable for implementing a method for controlling DRX, according to an embodiment.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

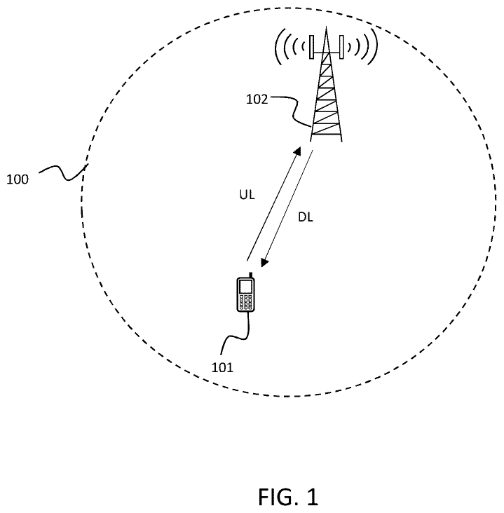

FIG. 1 shows an exemplary 5G New Radio (NR) wireless communication system 100 comprising a user equipment 101 and a base station 102 in which aspects of the present disclosure may be practiced. The wireless network 100 may be an LTE network or some other wireless network, such as 5G or NR network. The wireless network 100 may include one or more base stations 102. The base station 102 may be referred as BS, NB, eNodeB (or eNB), gNodeB (or gNB), an access point or the like, depending on the wireless standard implemented. Base station 102 provide radio communication coverage for a particular geographic area called “cell”. User equipment 101 may communicate with base station 102 through radio signals to access a core communication network. The base station 102 may communicate with user equipment 101 using downlink (DL) and uplink (UL) radio channels.

User equipment 101 may be referred as a mobile station, a wireless terminal, or the like. In some examples, user equipment 101 may be a cellular phone, a wireless modem, a wireless communication device, a handheld device, a laptop computer or the like. User equipment 101 may also be an IoT (internet of things) device, like wireless camera, a smart sensor or smart meter, a vehicle, a global positioning system device, or any other device configured to communicate through a wireless network.

The user equipment 101 and the base station 102 may communicate using Discontinuous reception (DRX). DRX is a processing mode in a user equipment that aims at reducing power consumption. When using DRX, a user equipment periodically enters an active state to receive downlink data and signaling and then enters a sleep state to stop monitoring on downlink data.

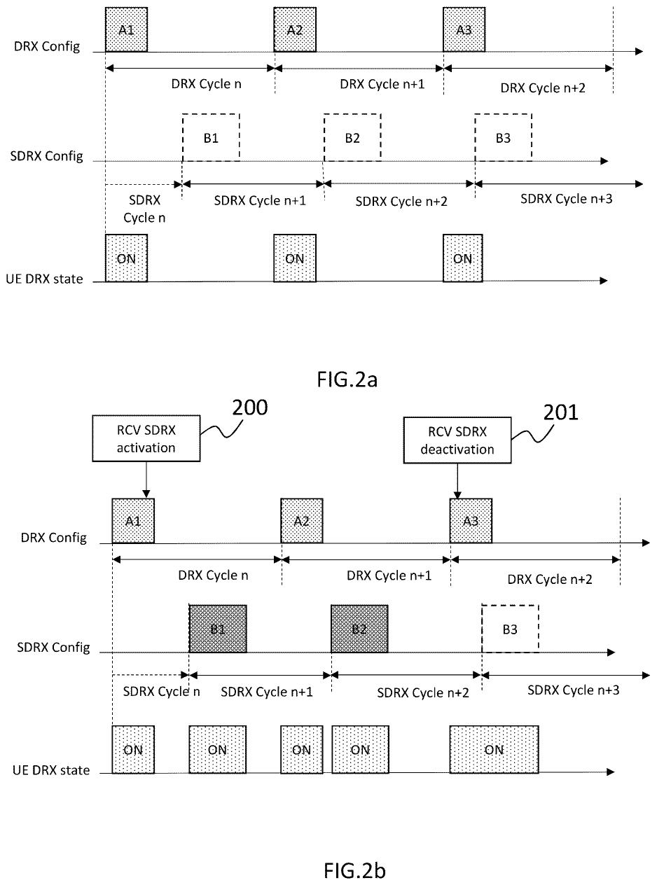

DRX is configured by the base station 102 using RRC (Radio Resource Control) signaling, e.g. RRC ConnectionReconfiguration or RRC Connection Setup. Among other, DRX parameters may include:
drx-onDurationTimer: the time during which user equipment should stay active after it wakes up (referenced as “Active Time” on FIG. 2a and FIG. 2b). During this period, user equipment should monitor a physical downlink channel (e.g., PDCCH).
drx-inactivityTimer: this parameter corresponds to the delay during which the user equipment should remain in active state after being scheduled.
drx-SlotOffset defines the start of ON duration relative to the start of subframe boundary.

Once configured by the network, DRX cycles may be repeated until a new DRX configuration is received.

In the following disclosure, reference will be made to user equipment 101 and base station 102 described above, with reference to FIG. 1.

FIGS. 2a and 2b show an exemplary primary DRX cycle configured in a user equipment, said cycle comprising an active time period (ON duration) and an inactive time period (OFF duration). DRX cycles are periodically repeated, leading to several ON durations noted A1, A2 and A3 for the primary DRX cycle and B1, B2, B3 for the secondary DRX cycle.

FIG. 2a is a schematic diagram of a primary DRX cycle and a secondary DRX cycle (SDRX) configuration, wherein the primary DRX cycle is activated and the second DRX cycle is not activated, i.e., user equipment does not wake up during SDRX ON periods. FIG. 2a further shows the resulting user equipment DRX state.

FIG. 2b is a schematic diagram of a primary DRX cycle and a secondary DRX cycle (SDRX) configuration, wherein the primary DRX cycle is activated. FIG. 2b also shows an activation command 200 received during ON period A1 on the primary DRX cycle. According to an embodiment, the receiving of the command 200 triggers the activation of the second DRX configuration. The user equipment may thus monitor downlink channel during the active time periods configured on secondary DRX until a deactivation command 201 is received on the primary DRX cycle period A3. Active time periods B1 and B2 are therefore activated for receiving downlink data and deactivated when no more downlink data is available.

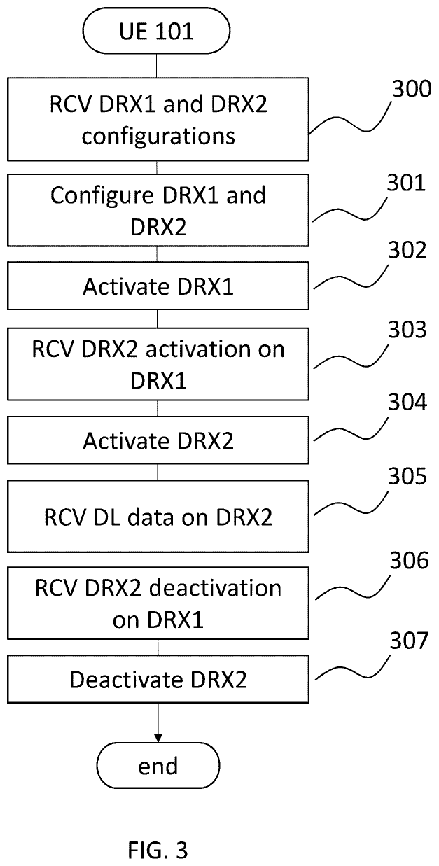

FIG. 3 is a flowchart showing main steps of a method performed by a user equipment 101 for configuring multiple DRX according to an embodiment of the present disclosure.

During a first step 300, user equipment 101 receives DRX configuration parameters sent by the base station 102.

These DRX configurations parameters may be transmitted by a base station 102 using RRC signaling, e.g., in a RRC connectionReconfiguration or RRC setup message. The DRX configurations comprise a set of DRX parameters suitable for the user equipment 101 to configure a primary DRX cycle and one or more secondary DRX cycles.

During step 301, the user equipment sets up a primary DRX cycle and a second DRX cycle according to the received configuration. Once configured, the user equipment 101 may activate (step 302) only the primary DRX configuration and keep the secondary DRX cycle inactive. The secondary DRX cycle is thus ready for quick on-demand activation.

At step 303, the user equipment 101 may receive a command for activating the preconfigured secondary DRX cycle. Because cycle characteristics are preconfigured, the command may include a mere activation flag associated with a specific DRX configuration, thus achieving low signaling overhead. According to an embodiment, the received command is received during a ON duration of a primary DRX cycle, on a L1/L2 downlink channel, e.g., on MAC CE and/or PDCCH.

In a possible embodiment, the secondary DRX activation MAC CE format may comprise one octet identified by a MAC subheader with LCID (Logical Channel Identifier). New LCID value may be selected from reserved LCID list as specified in 3GPP TS 38.321 in Table 6.2.1-1.

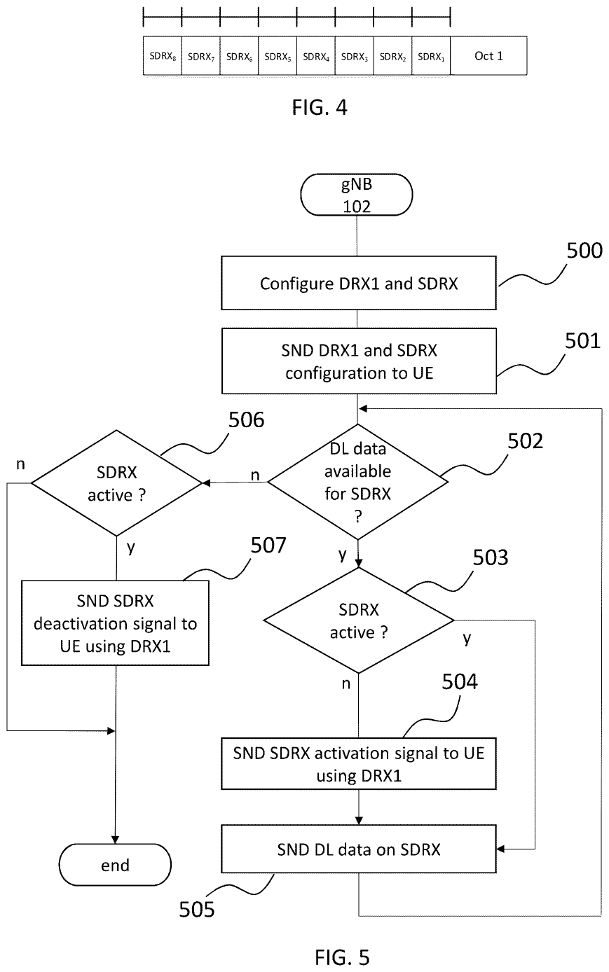

FIG. 4 illustrates an exemplary MAC CE format for secondary DRX activation/deactivation, in which a field SDRXi indicates the activation/deactivation status of the Secondary DRX with index i. The SDRXi field may be set to 1 to indicate that the SDRX with SDRXIndex i shall be activated. The SDRXi field is set to 0 to indicate that the SDRX with SCellIndex i shall be deactivated.

According to an embodiment, the activation command may include 3 bits for coding the SDRXIndex associated with an activation flag. The activation command may be transmitted over L1 signaling, e.g., in a PDCCH DCI format which indicates the activation/deactivation status of one or more secondary DRX cycles.

It is to be noted that activation of a specific secondary DRX and deactivation of another specific secondary DRX may be transmitted in a same signaling message. User equipment may then activate (step 304) one or more secondary DRX configurations according to the command received.

The user equipment may then receive downlink data during one or more ON periods of the newly activated secondary DRX until it receives (step 306) a command for deactivating said active secondary DRX configuration and deactivates (step 307) said secondary DRX accordingly.

According to an embodiment, the secondary DRX activation command may comprise comprises a time shift instruction, e.g., a time offset, for shifting secondary DRX cycles. It is contemplated that the shift instruction includes a positive or negative shifting offset parameter associated with a specific SDRXIndex. The user equipment shifts the starting of the next secondary DRX cycle of a specific secondary DRX configuration based on the provided offset. The present disclosure also contemplates that the provided offset could be a negative offset. This allows a base station to better synchronize the secondary DRX ON periods with the data rate and/or data arrival time/frequency.

FIG. 5 is a flowchart showing main steps of a method performed by a base station 102 for controlling multiple DRX in a user equipment according to an embodiment of the present disclosure.

The base station 102 first determine (step 500) a primary DRX configuration (DRX1) and at least one specific secondary DRX configuration (SDRX) for user equipment. The base station 102 may determine specific DRX and SDRX parameters depending on expected traffic flows characteristics. For example, the base station may determine specific DRX configurations to handle video, audio, data or poses traffic flows.

At step 501, the base station 102 transmits the determined DRX and SDRX configurations to a user equipment 102. These DRX configurations parameters may be transmitted by a base station 102 to the user equipment 101 using RRC signaling, e.g., in a RRC connectionReconfiguration or RRC setup message. The DRX configurations comprise a set of DRX parameters suitable for the user equipment 101 to configure a primary DRX cycle and one or more secondary DRX cycles.

The base station 102 periodically checks (step 502) for arrival of downlink data destinated to the user equipment 101. Upon arrival of a specific kind of data destinated to the user equipment 102, the base station 102 may store the incoming data in a specific buffer queue depending on the kind of data and/or traffic class, associated with a specific Secondary DRX configuration (e.g., SDRXIndex) to use for transmitting said data to the user equipment 101. The base station checks whether the corresponding SDRX configuration is already activated in user equipment 101 (step 502).

If the base station 102 determines that the determined SDRX configuration is currently inactive on user equipment 101, the base station 102 prepares and send (step 504) a command for activating said secondary DRX configuration.

The activation command may include a mere activation flag associated with a specific SDRX configuration (SDRXIndex), thus achieving low signaling overhead. According to an embodiment, the command is sent during a ON duration of the active primary DRX cycle, on a L1/L2 downlink channel, e.g., on MAC CE and/or PDCCH.

In a possible embodiment, the secondary DRX activation MAC CE format may comprise a number of bits, e.g., 8 bits identified by a MAC subheader with LCID (Logical Channel Identifier). New LCID value may be selected from reserved LCID list as specified in 3GPP TS 38.321 in Table 6.2.1-1.

Once the determined SDRX configuration has been activated on user agent 101 by the sending of the activation command at step 504, the base station 102 may send pending data (step 505) to the user equipment 101 during the corresponding SDRX ON periods.

The base station 102 may iterates back to step 502 to check is some more downlink data is to be transmitted on a specific SDRX cycle. When no more data is pending for a specific data flow, the base station may check (step 506) whether the corresponding SDRX configuration is already activated in user equipment 101.

If it is determined at step 506 that a SDRX configuration for which no more data is pending or/expected is still active, the base station 102 may prepare and send a SDRX deactivation command (step 507) over a primary DRX cycle. The deactivation command may use the same format and transmission mode as the activation command described hereinabove.

According to an embodiment, the base station 102 may determine a time offset to apply to a specific secondary DRX cycle in order to better align the data arrival rate with said SDRX ON periods.

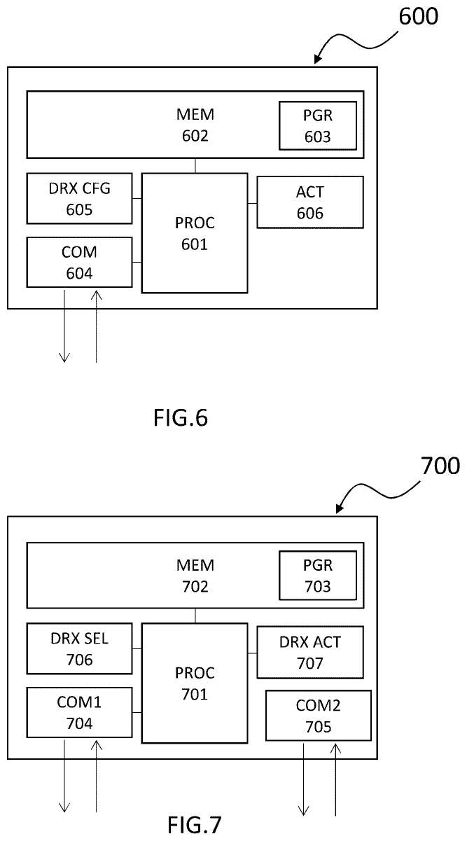

FIG. 6 shows a schematic architecture of an apparatus 600 suitable to implement a method for configuring discontinuous reception, according to an embodiment.

The apparatus 600 comprises a processor 601 and a memory 602, for example a Random Access Memory (RAM). The processor 601 may be controlled by a computer program 603 stored in the memory 602 comprising instructions configured to implement a method of wireless communication for controlling discontinuous reception according to an embodiment.

More precisely, the computer program 603 comprises instructions configured to implement steps of receiving DRX configuration parameters through RRC signaling, said parameters comprising a primary DRX cycle configuration and at least one secondary DRX cycle configuration, configuring said primary DRX cycle and said secondary DRX cycle, and activating only said primary DRX configuration, receiving from a network node, during said primary DRX cycle, a command for activating said at least one secondary DRX cycle, and activating said secondary DRX and receiving downlink data during said secondary DRX cycle.

On initialization, the computer program instructions 603 may be loaded into the memory 602 before being executed by the processor 601. The processor 601 implements the steps of the method according to the instructions of the computer program 603.

The apparatus 600 comprises a wireless communication unit 604, for example a LTE or 5G NR transceiver or the like. The communication unit 604 may be configured by computer program instructions to receive DRX configuration parameters from a network node, said configuration comprising a primary DRX configuration and at least a secondary DRX configuration using RRC connection.

The apparatus 600 may further comprise a DRX configuration unit 605 for configuring the wireless communication unit according to the received DRX configuration. The configuration unit 605 may be implemented by computer program instructions to parse a RRC message received by the communication unit 604 to extract and configure DRX parameters according to the parsed message.

The apparatus also comprises an activation unit 606 configured to activate and/or deactivate a specific DRX configuration. The activation unit 606 may be configured by computer program instructions adapted to initially activate a primary DRX configuration received by the communication module 604.

According to an embodiment, the communication unit 604 is further configured by computer program instructions to receive during an ON period of the configured and activated primary DRX cycle, a secondary DRX activation command comprising one or more DRX configuration identifier, transmitted over L1 and/or L2 message, for example a MAC CE message.

The activation unit 606 is further configured by computer program instructions for activating or deactivating a secondary DRX configuration according to the received DRX activation command.

The communication unit 604 is also configured to receive downlink data during said secondary DRX cycle.

According to an embodiment, the apparatus 600 is included in a user equipment device.

FIG. 7 shows a schematic architecture of an apparatus 700 suitable to implement a method for controlling discontinuous reception, according to an embodiment.

The apparatus 700 comprises a processor 701 and a memory 702, for example a Random Access Memory (RAM). The processor 701 may be controlled by a computer program 703 stored in the memory 702 comprising instructions configured to implement a method of wireless communication for configuring discontinuous reception according to an embodiment.

More precisely, the computer program 703 comprises instructions configured to implement steps of Sending (501) a primary DRX cycle configuration and at least one secondary DRX cycle configuration to a user equipment receiving downlink data destinated to said user equipment, determining at least one secondary DRX cycle associated with the received data, transmitting on said primary DRX cycle, a command for activating said determined secondary DRX cycle, and transmitting said downlink data the user equipment on said secondary DRX cycle.

On initialization, the computer program instructions 703 may be loaded into the memory 702 before being executed by the processor 701. The processor 701 implements the steps of the method according to the instructions of the computer program 703.

The apparatus 700 comprises a wireless communication unit 704, for example a LTE or 5G NR transceiver or the like. The communication unit 704 may be configured by computer program instructions to send DRX configuration parameters to a user equipment using a RRC connection, said configuration comprising a primary DRX configuration and at least a secondary DRX configuration.

The apparatus may further comprise a second communication unit 705 configured to receive downlink data from a core network. The second communication unit may be an optical communication unit, Ethernet, AT, etc.

The apparatus 700 also comprises a DRX configuration selection unit 706 configured to determine a specific DRX configuration cycle on which downlink data should be transmitted to a user equipment based on characteristics of a data flow received by the second communication unit 705.

The apparatus 700 further comprises a DRX activation unit 707 configured to activate a specific secondary DRX cycle in a user equipment when corresponding data is received by the second communication unit 705. The DRX activation unit may be configured by computer program instructions to prepare a L1/L2 message, for example a MAC CE message, comprising at least an activation command associated with an identifier of a secondary DRX cycle preconfigured in the target user equipment. According to an embodiment, the DRX activation unit may be configured to deactivate a specific DRX cycle in a user equipment when no more downlink data is pending for transmission by preparing a deactivation message comprising at least a deactivation command associated with an identifier of a secondary DRX cycle preconfigured in the target user equipment.

The wireless communication unit 704 may be further configured by computer program instructions to transmit to a user equipment an activation/deactivation message prepared by the activation unit 707 using L1/L2 signaling.

According to an embodiment, the apparatus 700 is included in a wireless network node, for example a base station, eNodeB or a gNodeB.

The present disclosure further contemplates a wireless communication system and/or a wireless network for controlling discontinuous reception, said system comprising an apparatus and/or user equipment implementing the above-described method for configuring DRX and a base station, eNodeB or gNodeB implementing the above-described method for controlling DRX.

1. A method of wireless communication for configuring multiple discontinuous reception (“DRX”) cycles by a user equipment connected to a wireless network, the method comprising:
receiving DRX configuration parameters through Radio Resource Control signaling, said parameters comprising a primary DRX cycle configuration and at least one secondary DRX cycle configuration,
configuring said primary DRX cycle and said secondary DRX cycle, and activating-(3 only said primary DRX configuration,
receiving from a network node, during said primary DRX cycle, a command for activating said at least one secondary DRX cycle, and
activating said secondary DRX and receiving downlink data during said secondary DRX cycle.

2. A method according to claim 1 further comprising receiving during said primary DRX cycle, a command for deactivating said at least one secondary DRX cycle.

3. A method according to claim 1 wherein said received secondary DRX cycle activation command includes at least an instruction for time-shifting said at least one secondary DRX cycle.

4. A method according to claim 1 wherein said secondary DRX cycle activation command is received through Physical layer and/or Medium Access Control signaling.

5. A method according to claim 4 wherein said secondary DRX cycle activation command is carried over Medium Access Control Element and/or Physical Downlink Control Channel.

6. A method according to claim 1 wherein said secondary DRX cycle activation command is transmitted in an 8-bit field of a Medium Access Control subheader with Logical Channel Identifier.

7. A method according to claim 1 wherein said secondary DRX cycle activation command is transmitted in a 3-bit field of a Downlink Control Information format.

8. A method of wireless communication by a base station, for controlling multiple discontinuous reception (“DRX”) cycles in a user equipment connected to a wireless network, the method comprising:
sending a primary DRX cycle configuration and at least one secondary DRX cycle configuration to a user equipment,
receiving downlink data destinated to said user equipment,
determining at least one secondary DRX cycle associated with the received data,
transmitting on said primary DRX cycle, a command for activating said determined secondary DRX cycle, and
transmitting said downlink data the user equipment on said secondary DRX cycle.

9. A method according to claim 8 further comprising sending on said primary DRX cycle, a command for deactivating said at least one secondary DRX cycle.

10. A method according to claim 8 wherein said DRX cycle activation command transmitted includes at least an instruction for time-shifting said at least one secondary DRX cycle.

11. A method according to claim 8 wherein said secondary DRX cycle activation command is transmitted through Physical layer and/or Medium Access Control signaling.

12. A method according to claim 11 wherein said secondary DRX cycle activation command is carried over Medium Access Control Element and/or Physical Downlink Control Channel.

13. A method according to claim 8 wherein said secondary DRX cycle activation command is transmitted in an 8-bit field of a Medium Access Control subheader with Logical Channel Identifier.

14. A method according to claim 8 wherein said secondary DRX cycle activation command is transmitted in a 3-bit field of a Downlink Control Information format.

15. An apparatus for configuring multiple discontinuous reception (“DRX”) cycles in a user equipment connected to a wireless network, said apparatus comprising a processor coupled with a memory, said memory comprising computer program instructions stored therein for controlling said processor, wherein said computer program instructions are configured to implement the following acts:
receiving DRX configuration parameters through Radio Resource Control signaling, said parameters including a primary DRX cycle configuration and at least one secondary DRX cycle configuration,
configuring said primary DRX cycle and said secondary DRX cycle, and activating only said primary DRX configuration,
receiving from a network node, during said primary DRX cycle, a command for activating said at least one secondary DRX cycle, and
activating said secondary DRX and receiving downlink data during said secondary DRX cycle.

16. An apparatus for controlling multiple discontinuous reception (“DRX”) cycles in a wireless network, said apparatus comprising a processor coupled with a memory, said memory comprising computer program instructions stored therein for controlling said processor, wherein said computer program instructions are configured to implement the following acts:
sending a primary DRX cycle configuration and at least one secondary DRX cycle configuration to a user equipment,
receiving downlink data destinated to said user equipment,
determining at least one secondary DRX cycle associated with the received data,
transmitting on said primary DRX cycle, a command for activating said determined secondary DRX cycle, and
transmitting said downlink data the user equipment on said secondary DRX cycle.

17-20. (canceled)
